(19) United States
(12) Patent Application Publication
(10) Pub. No.: US 2021/0333102 A1
(43) Pub. Date: Oct. 28, 2021

(54) STATE PREDICTION DEVICE AND STATE PREDICTION METHOD

(71) Applicant: Mitsubishi Electric Corporation, Tokyo (JP)

(72) Inventors: Tetsutaro YAMADA, Tokyo (JP); Tomoyuki KOYANAGI, Tokyo (JP); Toshihiko ARIOKA, Tokyo (JP); Hiroaki ISHIKAWA, Tokyo (JP); Hiroshi KAMEDA, Tokyo (JP)

(73) Assignee: Mitsubishi Electric Corporation, Tokyo (JP)

(21) Appl. No.: 17/368,193

(22) Filed: Jul. 6, 2021

Related U.S. Application Data
(63) Continuation of application No. PCT/JP2019/002267, filed on Jan. 24, 2019.

(51) Int. Cl. G01C 13/00; G01S 13/95

(52) U.S. Cl. CPC G01C 13/006; G01S 13/95

(57) ABSTRACT

The state prediction device smoothes a state vector including a flow rate and a water level of a tsunami at each of a plurality of points set two-dimensionally in a region including a coverage area, by using flow velocity observed values of a sea surface in a plurality of cells extending in a plurality of range directions and a plurality of beam directions in the coverage area of a radar.

### CROSS REFERENCE TO RELATED APPLICATIONS

This application is a Continuation of PCT International Application No. PCT/JP2019/002267, filed on Jan. 24, 2019, all of which is hereby expressly incorporated by reference into the present application.

### TECHNICAL FIELD

The present invention relates to, for example, a state prediction device and a state prediction method for predicting the water level and flow velocity of a tsunami.

### BACKGROUND ART

For example, Non-Patent Literature 1 describes a technique for predicting the water level of a tsunami in real time from flow velocity observed values of the sea surface observed by a radar, using a nonlinear shallow water equation that defines a tsunami movement model.

### CITATION LIST

### Non-Patent Literature

Non-Patent Literature 1: BELINDA J. LIPA, DONALD E. BARRICK, JOHN BOURG and BRUCE B. NYDEN, “HF Radar Detection of Tsunamis”, Journal of Oceanography, Vol. 62, pp. 705 to 716, 2006.

### SUMMARY OF INVENTION

### Technical Problem

As in Non-Patent Literature 1, a technique for predicting a tsunami state in real time has been proposed, but in order to alert people to the tsunami approaching as soon as possible, it is necessary to accurately predict a tsunami state in real time.

The present invention solves the above problem, and has an object to obtain a state prediction device and a state prediction method capable of accurately predicting a tsunami state in real time.

### Solution to Problem

The state prediction device according to the present invention includes: processing circuitry to predict a state vector at next time using a two-dimensional shallow water equation that expresses propagation of a tsunami, the state vector including a flow rate and a water level of a tsunami at each of a plurality of points set two-dimensionally in a region including a coverage area of a radar; collectively smooth the predicted state vector in the coverage area using a Kalman filter, by using a Kalman gain, the predicted state vector, and an observation vector including flow velocity observed values of a sea surface in a plurality of cells extending in a plurality of range directions and a plurality of beam directions in the coverage area; and set an initial value used for the prediction of the state vector.

### Advantageous Effects of Invention

According to the present invention, since the state vector including a flow rate and a water level of a tsunami at each of a plurality of points set two-dimensionally in a region including a coverage area is smoothed, by using flow velocity observed values of a sea surface in a plurality of cells extending in a plurality of range directions and a plurality of beam directions in the coverage area of a radar, the tsunami state can be predicted accurately in real time.

### BRIEF DESCRIPTION OF DRAWINGS

FIG. 1 is a block diagram showing a configuration of a state prediction device according to a first embodiment.

FIG. 2 is a diagram showing the relationship between a radar coverage area and a tsunami.

FIG. 3 is a diagram showing the relationship between the radar coverage area and a tsunami state vector.

FIG. 4 is a flowchart showing a state prediction method according to the first embodiment.

FIG. 5A is a diagram showing the radar coverage area and the tsunami state vector. FIG. 5B is a diagram showing the radar coverage area and the state vector bundled in cells of the coverage area. FIG. 5C is a diagram showing the radar coverage area and an observation vector.

FIG. 6A is a block diagram showing a hardware configuration for implementing functions of the state prediction device according to the first embodiment. FIG. 6B is a block diagram showing a hardware configuration for executing software that implements functions of the state prediction device according to the first embodiment.

### DESCRIPTION OF EMBODIMENTS

### First Embodiment

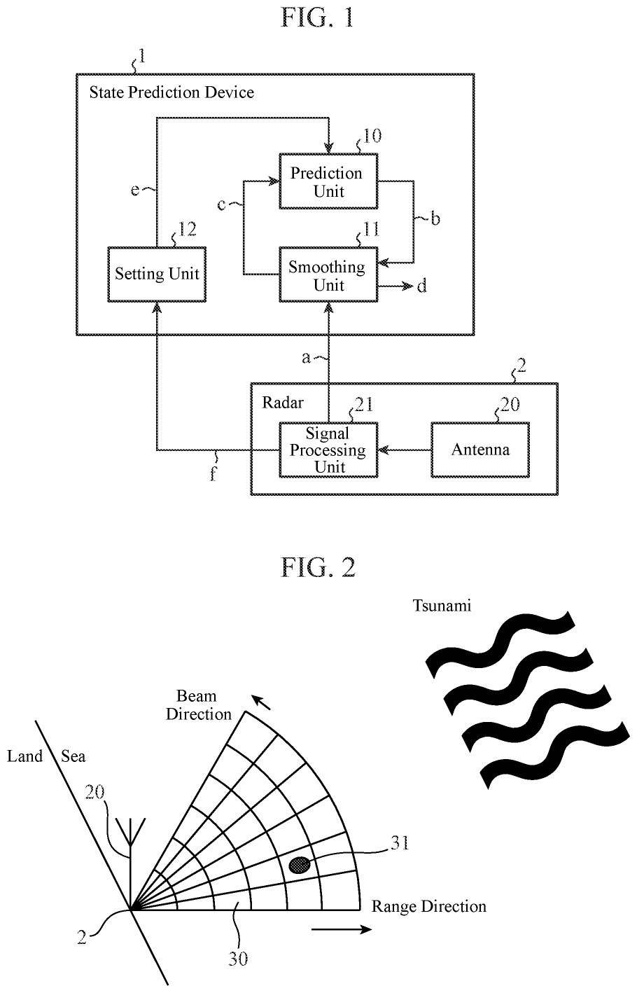

FIG. 1 is a block diagram showing a configuration of a state prediction device 1 according to the first embodiment. FIG. 2 is a diagram showing the relationship between a coverage area 30 of a radar 2 and a tsunami. Further, FIG. 3 is a diagram showing the relationship between the coverage area 30 of the radar 2 and a state vector of the tsunami. As shown in FIG. 1, the state prediction device 1 is a device that predicts a tsunami state by using flow velocity observed values a of a sea surface observed by the radar 2, and includes a prediction unit 10, a smoothing unit 11, and a setting unit 12. As shown in FIG. 2, the coverage area 30 of the radar 2 is divided into a plurality of areas in the range direction (distance direction) and the beam direction (azimuth direction), and each of the divided areas is a cell 31. The radar 2 is a device for observing a flow velocity of a sea surface for each cell 31 in the coverage area 30, and includes an antenna 20 and a signal processing unit 21.

The prediction unit 10 predicts the state vector at the next time. The state vector is a vector including a flow rate and a water level of a tsunami at each of a plurality of points set two-dimensionally in the region including the coverage area 30 of the radar 2. For example, the state vector shown in FIG. 3 includes the flow rate and water level of the tsunami in each of regions corresponding to a plurality of grid points 40 set in the region including the coverage area 30. When the number of grid meshes in the X-axis direction in FIG. 3 is I and the number of grid meshes in the Y-axis direction is J, the state vector is a vector having a dimension of I×J×3. In the following description, the X-axis direction is the east-west direction, and the Y-axis direction is the north-south direction.

Assuming that the flow rate of the tsunami in the X-axis direction is M, the flow rate of the tsunami in the Y-axis direction is N, and the water level of the tsunami in the area corresponding to each grid point is H, the state vector at time k can be expressed by the following equation (1). k is a sampling time number. X(k) is a state vector of the tsunami at time k.

$$X ( k ) = ( \begin{matrix}{M}_{1 , 1} ( k ) \\ {M}_{2 , 1} ( k ) \\ … \\ {M}_{I - 1 , J} ( k ) \\ {M}_{I , J} ( k ) \\ {N}_{1 , 1} ( k ) \\ {N}_{2 , 1} ( k ) \\ … \\ {N}_{I - 1 , J} ( k ) \\ {N}_{I , J} ( k ) \\ {H}_{1 , 1} ( k ) \\ {H}_{2 , 1} ( k ) \\ … \\ {H}_{I - 1 , J} ( k ) \\ {H}_{I , J} ( k )\end{matrix} ) \qquad ( 1 )$$

In the above equation (1), Mᵢⱼ is a flow rate of the tsunami in the X-axis direction in an area corresponding to a grid point 40 which is the i-th (i=1, 2, . . . , I) grid point in the X-axis direction and the j-th (j=1, 2, . . . , J) grid point in the Y-axis direction, and Nᵢⱼ is a flow rate of the tsunami in the Y-axis direction in an area corresponding to a grid point 40 which is the i-th grid point in the X-axis direction and the j-th grid point in the Y-axis direction. Hᵢⱼ is a water level of the tsunami in an area corresponding to a grid point 40 which is the i-th grid point in the X-axis direction and the j-th grid point in the Y-axis direction.

The prediction unit 10 predicts a state vector X(k+1|k)) at the next time k+1 from the smoothed state vector X(k|k) at time k by using a two-dimensional shallow water equation expressing the propagation of the tsunami. As for the shallow water equation, for example, a two-dimensional shallow water equation expressing the propagation of the tsunami at the plurality of grid points 40 set in a region including the coverage area 30 is used.

The smoothing unit 11 smoothes a state vector b predicted by the prediction unit 10, by using the flow velocity observed values a of the sea surface in the plurality of cells 31 extending in the plurality of range directions and the plurality of beam directions in the coverage area 30. Smoothing is a process of removing the prediction error included in the flow rate and water level of the tsunami that constitute the state vector b.

For example, the smoothing unit 11 linearly interpolates the state vector b to create an observation matrix, and smoothes the state vector b using the created observation matrix. The observation matrix is a matrix that linearly transforms a state vector into an observation vector. The observation vector is a vector including the flow velocity observed values of the sea surface in the plurality of cells 31.

A state vector c smoothed by the smoothing unit 11 is output from the smoothing unit 11 to the prediction unit 10. Further, the smoothing unit 11 outputs, as a prediction result d, a smoothed flow rate and a smoothed water level calculated for each observation interval by the radar 2.

The setting unit 12 sets, in the prediction unit 10, an initial value e used for the prediction of the state vector. For example, the setting unit 12 calculates the initial value e using an observed value f input from the radar 2, and sets the calculated initial value e in the prediction unit 10. The prediction unit 10 predicts the state vector at the next time by using the initial value e of the state vector set by the setting unit 12, in the initial phase of searching for the tsunami, and predicts the state vector at the next time by using the state vector smoothed by the smoothing unit 11, in a tsunami tracking phase.

The antenna 20 transmits an electromagnetic wave toward the sea surface which is an observation region, and receives the electromagnetic wave reflected by the sea surface. On the basis of the electromagnetic wave received by the antenna 20, the signal processing unit 21 observes the flow velocity observed values a of the sea surface in the plurality of cells 31 extending in the plurality of range directions and the plurality of beam directions in the coverage area 30, and outputs the observed flow velocity observed values a to the smoothing unit 11. Further, the signal processing unit 21 calculates the flow rate in the traveling direction of the tsunami, on the basis of the flow velocity observed values a of the sea surface corresponding to the cells 31 including the tsunami, and outputs the calculated flow rate as the observed value f to the setting unit 12.

Next, the operation of the state prediction device 1 will be described.

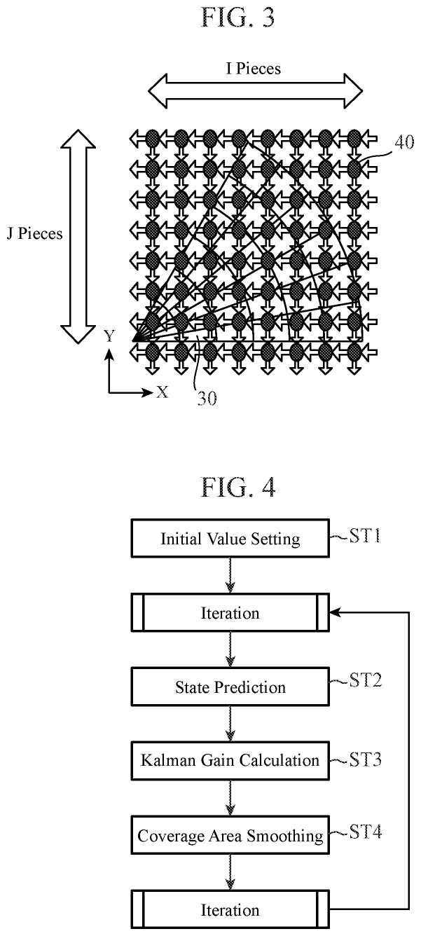

FIG. 4 is a flowchart showing a state prediction method according to the first embodiment, and shows the operation of the state prediction device 1. First, the setting unit 12 sets, in the prediction unit 10, the initial value e used for predicting the state vector in the prediction unit 10 (step ST1). For example, the setting unit 12 calculates the tsunami state vector on the basis of wave surface information of the tsunami, and sets the calculated state vector in the prediction unit 10 as the initial value e. Here, the tsunami wave surface information is information indicating the cell 31 including the tsunami wave surface among the plurality of cells 31 obtained by dividing the coverage area 30 of the radar 2.

The setting unit 12 calculates a state vector (M N H) in accordance with the following equations (2), (3), and (4) for the cell 31 including the tsunami wave surface among the plurality of cells 31, selects a mesh corresponding to the cell 31 from among the plurality of meshes of the grid set in the region including the coverage area 30, and sets the calculated state vector (M N H) as the initial value e of the tsunami state vector at the grid point of the selected mesh. On the other hand, the setting unit 12 sets the initial value e to zero for the grid point of the mesh corresponding to the cell 31 that does not include the tsunami wave surface.

Note that, in the following equations (2) to (4), V is the flow rate of the tsunami in the traveling direction, and is the observed value f calculated by the signal processing unit 21. φ is an angle formed by the X-axis and the traveling direction of the tsunami, g is the gravitational acceleration, and D is the water depth.

$$\begin{matrix}M = V cos ϕ & ( 2 ) \\ N = V sin ϕ & ( 3 ) \\ H = V \sqrt{\frac{1}{g D}} & ( 4 )\end{matrix}$$

Note that, for the calculation of the flow rate and water level of the tsunami based on the wave surface information of the tsunami, for example, the technique described in Reference 1 below can be used.

(Reference 1) Japanese Patent No. 6440912

Further, the setting unit 12 may calculate the tsunami state vector on the basis of an inverse analysis result of the tsunami. The inverse analysis of the tsunami is a process of calculating the fluctuation of the flow rate and water level in a small area of the observation region, from the time-series fluctuation of the flow rate and water level of the tsunami observed for each mesh, by using an observation position response function. The flow rate and water level of the tsunami in the mesh calculated by the setting unit 12 are set, in the prediction unit 10, as the initial value e of the state vector at the grid point of the mesh.

Further, the setting unit 12 may calculate an initial value P_{2:2} of a smoothing error covariance matrix in accordance with the following equation (5), and set P_{2:2} as the initial value e in the prediction unit 10. In the following equation (5), R is an observation error covariance matrix, and sets the covariance of the cell flow velocity error.

$${P}_{2 : 2} = ( \begin{matrix}DRD & O & O \\ O & DRD & O \\ O & O & \frac{1}{g} DR\end{matrix} ) \qquad ( 5 )$$

When initial value setting is completed, the process shifts to an iterative process in which the state prediction, the Kalman gain calculation, and the coverage area smoothing process are sequentially executed for each observation interval by the radar 2.

Using the state vector X(k|k) at the current time k, the prediction unit 10 calculates a state vector X(k+1|k) and a prediction error covariance matrix P_{k+1:k} at the next time in accordance with the following equation (6) (step ST2). Note that, in the following equation (6), the state vector X(k|k) is a state vector at time k smoothed by the smoothing unit 11.

X(k+1|k)=FX(k|k) (6)

In the above equation (6), F is a transition matrix representing a prediction. For example, the prediction unit 10 linearly transforms the state vector at the time k into the state vector at the next time k+1 in accordance with the following equations (7), (8), and (9). The following equations (7) to (9) are two-dimensional shallow water equations that express the propagation of a tsunami. Note that, g is the gravitational acceleration, dt is the time interval between time k and time k+1, and dx is the interval between grid points. Further note that, in the following equations (7) to (9), H_{i,j-1}(k) is expressed by the following equation (10), H_{i-1,j}(k) is expressed by the following equation (11), M_{i,J+1}(k) is expressed by the following equation (12), and N_{i+1,j}(k) is expressed by the following equation (13). Further, the following equations (10) to (13) show the reflection conditions in the boundary cell.

$$\begin{matrix} {M}_{i , j} ( k + 1 ) = {M}_{i , j} ( k ) - gD \frac{dt}{d x} ( {H}_{i , j} ( k ) - {H}_{i - 1 , j} ( k ) ) & ( 7 ) \\ {N}_{i , j} ( k + 1 ) = {N}_{i , j} ( k ) - gD \frac{dt}{d x} ( {H}_{i , j} ( k ) - {H}_{i , j - 1} ( k ) ) & ( 8 ) \\ {H}_{i , j} ( k + 1 ) = {H}_{i , j} ( k ) - \frac{dt}{d x} ( {M}_{i , j + 1} ( k ) - {M}_{i , j} ( k ) + {N}_{i + 1 , j} ( k ) - {N}_{i , j} ( k ) ) & ( 9 ) \\ {H}_{i , j - 1} ( k ) = {H}_{i , j} ( k ) & ( 10 ) \\ {H}_{i - 1 , j} ( k ) = {H}_{i , j} ( k ) & ( 11 ) \\ {M}_{i , j + 1} ( k ) - {M}_{i , j} ( k ) & ( 12 ) \\ {N}_{i + 1 , j} ( k ) - {N}_{i , j} ( k ) & ( 13 )\end{matrix}$$

The prediction unit 10 calculates the prediction error covariance matrix P_{k+1:k} in accordance with the following equation (14). In the following equation (14), P_{k:k} is the smoothing error covariance matrix, F^{t} represents transposition of the transition matrix F, G is a process noise transformation matrix, and G^{t} represents transposition of the process noise transformation matrix G. Q is a process noise covariance matrix, and Q=qI_{d}. q is a process noise parameter, Id is an identity matrix of the size of d×d, and d=I×J. The following equation (14) assumes that the water level difference fluctuates in accordance with the normal distribution when the tsunami moves. For example, the prediction unit 10 can generate the transition matrix F, in consideration of boundary conditions regarding reflection, transmission, and superposition, on the sea surface, of electromagnetic waves from the radar 2. The process noise transformation matrix G can be expressed by the following equations (15) and (16).

$$\begin{matrix}{P}_{k + 1 : k} = {FP}_{k : k} {F}^{ t} + {GQG}^{ t} & ( 14 ) \\ G = ( \begin{matrix}{G }^{′} \\ {G }^{′} \\ {I}_{d}\end{matrix} ) & ( 15 ) \\ {G }^{′} = ( - gDdt / dx ) {I}_{d} & ( 16 )\end{matrix}$$

Subsequently, the smoothing unit 11 calculates the Kalman gain K(k) at time k (step ST3). For example, the smoothing unit 11 calculates the Kalman gain K(k) at time k in accordance with the following equation (17). E in the following equation (17) is an observation matrix. E^{t} is the transposition of the observation matrix E.

K(k)=P_{k+1:k}(k)E^{t}[EP_{k+1:k}E^{t}+R] (17)

The observation matrix E is a matrix that linearly transforms the state vector X(k) into an observation vector Z(k) as shown in the following equation (18). The observation vector Z(k) is including flow velocity observed value of the sea surface corresponding to each of the plurality of cells 31 in the coverage area 30 observed by the radar 2 at time k. For example, the observation vector Z(k) is Z(k)={z_{1,1} (k) z_{2,1} (k) . . . z_{r,s}(k)}. z_{r,s} is a flow velocity observed value of a sea surface in the cell 31 of range number r and beam number s. The range number r is a serial number assigned in the range direction of the cell 31, and the beam number s is a serial number assigned in the beam direction of the cell 31.

Z(k)=EX(k) (18)

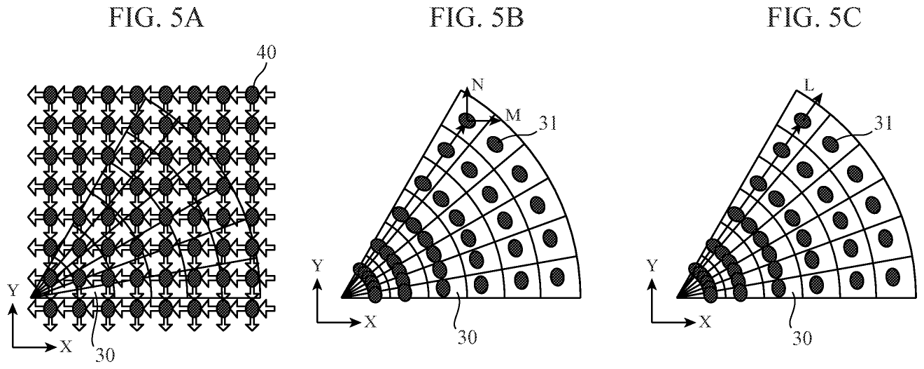

FIG. 5A is a diagram showing the coverage area 30 and the tsunami state vector. FIG. 5B is a diagram showing the coverage area 30 and the state vector bundled in the cell 31 of the coverage area 30. FIG. 5C is a diagram showing the coverage area 30 and the observation vector. The state vector shown in FIG. 5A has, as elements, the flow rate and water level of the tsunami in each of the regions corresponding to the plurality of grid points 40, and has a dimension of I×J×3.

Hereinafter, the number of cells 31 in the range direction of the coverage area 30 is R, and the number of cells 31 in the beam direction is S.

As shown in FIG. 5B, a matrix A in the following equation (19) is a matrix having I×J×3 columns and R×S×3 rows that associates the I×J×3 state vector with a plurality of cells 31 in the coverage area 30. As for the association between the state vector and the cell 31 by using the matrix A, for example, a method of selecting a grid point nearest to the cell or a method of performing linear interpolation can be used. As for an example of linear interpolation, instead of selecting the grid point nearest to one cell, by using top two grid points nearest to the cell, state vectors of the two grid points may be weighted and averaged inversely proportional to the distances. Since the elements of each grid point 40 are bundled in the corresponding cell 31 by performing the operation of the matrix A on the I×J×3 state vector X(k), the dimension of the state vector is reduced to R×S×3. The elements of the state vector associated with the cell 31 are the flow rate M in the X-axis direction, the flow rate N in the Y-axis direction, and the water level H of the tsunami, as shown in FIG. 5B.

E=BA (19)

As shown in FIG. 5C, the matrix B in the above equation (19) is a matrix having R×S×3 columns and R×S rows and projecting the flow rate of each element of the R×S×3 state vector of the coverage area 30 onto the flow velocity in the line-of-sight direction. Each element of the matrix B linearly transforms the flow rates M_{r,s} and N_{r,s} into z_{r,s} in accordance with the following equation (20). z_{r,s} is a flow velocity observed value of the sea surface corresponding to the cell 31 of the range number r and the beam number s. As shown in FIG. 5C, it is possible to obtain a projection flow velocity vector L, which is z_{r,s}, from the elements of each cell 31 by performing the operation of the matrix B on the R×S×3 state vector. Here, (p_{r,s}, q_{r,s}) represents a position vector to a cell of the range number r and the beam number s with respect to the installation point of the radar device.

Z_{r,s}={(p_{r,s},q_{r,s})·(M_{r,s},N_{r,s})}/D_{r,s}|(p_{r,s},q_{r,s})| (20)

Subsequently, the smoothing unit 11 performs the coverage area smoothing process (step ST4). For example, the smoothing unit 11 calculates the smoothed state vector X_{k+1:k+1} at the next time k+1 by using the Kalman gain K(k), the observation vector Z(k), and the state vector X_{k+1:k} predicted by the prediction unit 10 in accordance with the following equation (21). This is a smoothing process of the state vector using a Kalman filter in which the observation matrix E is expressed by the matrix B×the matrix A. Further, since the observation vector Z(k) is flow velocity observed values of the sea surface in a plurality of cells 31 extending in a plurality of range directions and a plurality of beam directions in the coverage area 30, the state vector X_{k+1:k+1} is a vector obtained by collectively smoothing the flow velocity vectors of the sea surface observed in the coverage area 30.

X_{k+1:k+1}=X_{k+1:k}+K(k)(Z(k)−EX_{k+1:k}) (21)

Next, the hardware configuration that implements the functions of the state prediction device 1 will be described.

The functions of the prediction unit 10, the smoothing unit 11, and the setting unit 12 in the state prediction device 1 are implemented by a processing circuit. That is, the state prediction device 1 includes a processing circuit for executing the processing from step ST1 to step ST4 in FIG. 4. The processing circuit may be dedicated hardware or a central processing unit (CPU) that executes a program stored in a memory.

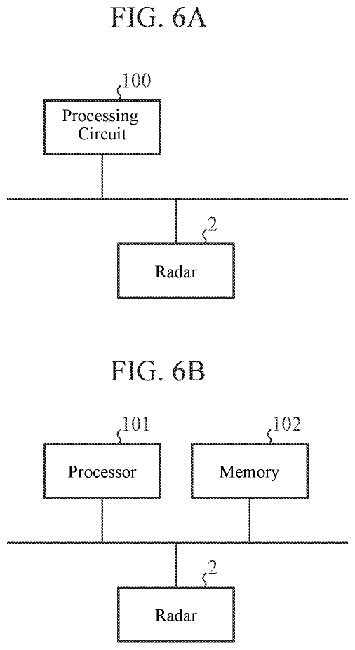

FIG. 6A is a block diagram showing a hardware configuration for implementing the functions of the state prediction device 1. FIG. 6B is a block diagram showing a hardware configuration for executing software that implements the functions of the state prediction device 1. In FIGS. 6A and 6B, the radar 2 is a radar having the configuration shown in FIG. 1.

In a case where the processing circuit is a processing circuit 100 of dedicated hardware shown in FIG. 6A, the processing circuit 100 corresponds, for example, to a single circuit, a composite circuit, a programmed processor, a parallel-programmed processor, an application specific integrated circuit (ASIC), a field-programmable gate array (FPGA), or a combination thereof. The functions of the prediction unit 10, the smoothing unit 11, and the setting unit 12 in the state prediction device 1 may be implemented by separate processing circuits, or these functions may be collectively implemented by one processing circuit.

When the processing circuit is a processor 101 shown in FIG. 6B, the functions of the prediction unit 10, the smoothing unit 11, and the setting unit 12 in the state prediction device 1 are implemented by software, firmware, or a combination of software and firmware. Note that, software or firmware is described as a program and stored in a memory 102.

The processor 101 implements the functions of the prediction unit 10, the smoothing unit 11, and the setting unit 12 in the state prediction device 1 by reading and executing programs stored in the memory 102. For example, the state prediction device 1 includes a memory 102 for storing programs which when executed by the processor 101, allow the processing from step ST1 to step ST4 of the flowchart shown in FIG. 4 to be executed as a result. These programs cause a computer to execute procedures or methods performed by the prediction unit 10, the smoothing unit 11, and the setting unit 12. The memory 102 may be a computer-readable storage medium that stores a program for causing the computer to function as the prediction unit 10, the smoothing unit 11, and the setting unit 12.

The memory 102 corresponds, for example, to a nonvolatile or volatile semiconductor memory, such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, or a DVD.

Some of functions of the prediction unit 10, the smoothing unit 11, and the setting unit 12 in the state prediction device 1 may be implemented by dedicated hardware and some of the functions may be implemented by software or firmware. For example, the function of the prediction unit 10 is implemented by the processing circuit 100 which is the dedicated hardware, and the functions of the smoothing unit 11 and the setting unit 12 are implemented by the processor 101 reading and executing the programs stored in the memory 102. Thus, the processing circuit can implement each of the above functions by hardware, software, firmware, or a combination thereof.

As described above, in the state prediction device 1 according to the first embodiment, the tsunami state vector corresponding to the plurality of grid points 40 set in the region including the coverage area 30 are smoothed, by using the flow velocity observed values of the sea surface corresponding to the plurality of cells 31 extending in the plurality of range directions and the plurality of beam directions in the coverage area 30 of the radar 2. In this way, the flow velocity vectors of the sea surface observed in the coverage area 30 are smoothed collectively, so that even when the radar 2 is a single radar, real-time tsunami prediction and tsunami state smoothing can be performed, and the accuracy of flow velocity estimation and the accuracy of water level estimation of the tsunami are improved as compared with conventional techniques.

The present invention is not limited to the above-described embodiment, and within the scope of the present invention, it is possible to modify any component of the embodiment or omit any component of the embodiment.

### INDUSTRIAL APPLICABILITY

Since the state prediction device according to the present invention can accurately predict the tsunami state in real time, it can be used in a radar system that predicts the water level and flow velocity of the tsunami.

### REFERENCE SIGNS LIST

1: state prediction device, 2: radar, 10: prediction unit, 11: smoothing unit, 12: setting unit, 20: antenna, 21: signal processing unit, 30: coverage area, 31: cell, 40: grid point, 100: processing circuit, 101: processor, 102: memory

1. A state prediction device comprising:
processing circuitry to
predict a state vector at next time using a two-dimensional shallow water equation that expresses propagation of a tsunami, the state vector including a flow rate and a water level of a tsunami at each of a plurality of points set two-dimensionally in a region including a coverage area of a radar;
collectively smooth the predicted state vector in the coverage area using a Kalman filter, by using a Kalman gain, the predicted state vector, and an observation vector including flow velocity observed values of a sea surface in a plurality of cells extending in a plurality of range directions and a plurality of beam directions in the coverage area; and
set an initial value used for the prediction of the state vector.

2. A state prediction device comprising:
processing circuitry to
predict a state vector at next time, the state vector including a flow rate and a water level of a tsunami at each of a plurality of points set two-dimensionally in a region including a coverage area of a radar;
linearly interpolates the predicted state vector to create an observation matrix that linearly transforms the state vector into an observation vector including flow velocity observed values of a sea surface in a plurality of cells extending in a plurality of range directions and a plurality of beam directions in the coverage area, and smooth the state vector using the created observation matrix; and
set an initial value used for the prediction of the state vector.

3. The state prediction device according to claim 2, wherein
the processing circuitry predicts the state vector using a two-dimensional shallow water equation that expresses propagation of a tsunami.

4. The state prediction device according to claim 2, wherein
the processing circuitry predicts the state vector using a two-dimensional shallow water equation expressing the propagation of a tsunami at a plurality of grid points set in a region including the coverage area.

5. The state prediction device according to claim 1, wherein
the processing circuitry calculates the state vector on a basis of wave surface information of a tsunami, and sets the calculated state vector as the initial value.

6. The state prediction device according to claim 1, wherein
the processing circuitry calculates the state vector on a basis of a reverse analysis result of a tsunami, and sets the calculated state vector as the initial value.

7. The state prediction device according to claim 2, wherein
the processing circuitry calculates the state vector on a basis of wave surface information of a tsunami, and sets the calculated state vector as the initial value.

8. The state prediction device according to claim 2, wherein
the processing circuitry calculates the state vector on a basis of a reverse analysis result of a tsunami, and sets the calculated state vector as the initial value.

9. A state prediction method using a state prediction device provided with processing circuitry, the state prediction method comprising:
setting an initial value used for predicting a state vector including a flow rate and a water level of a tsunami at each of a plurality of points set two-dimensionally in a region including a coverage area of a radar;
predicting the state vector at next time using a two-dimensional shallow water equation that expresses propagation of a tsunami; and
collectively smoothing the predicted state vector in the coverage area using a Kalman filter, by using a Kalman gain, the predicted state vector, and an observation vector including flow velocity observed values of a sea surface in a plurality of cells extending in a plurality of range directions and a plurality of beam directions in the coverage area.

10. A state prediction method using a state prediction device provided with processing circuitry, the state prediction method comprising:
setting an initial value used for predicting a state vector including a flow rate and a water level of a tsunami at each of a plurality of points set two-dimensionally in a region including a coverage area of a radar;
predicting the state vector at next time; and
linearly interpolates the predicted state vector to create an observation matrix that linearly transforms the state vector into an observation vector including flow velocity observed values of a sea surface in a plurality of cells extending in a plurality of range directions and a plurality of beam directions in the coverage area, and smoothing the state vector using the created observation matrix.
